(19) United States
(12) Patent Application Publication
(10) Pub. No.: US 2007/0022306 A1
(43) Pub. Date: Jan. 25, 2007

(54) Method and apparatus for providing protected digital content

(76) Inventor: Brett L. Lindsley, Wheaton, IL (US)

Correspondence Address: MOTOROLA, INC., 1303 EAST ALGONQUIN ROAD, IL01/3RD, SCHAUMBURG, IL, 60196, US

(21) Appl. No.: 11/188,317

(22) Filed: Jul. 25, 2005

(51) Int. Cl. G06F 12/14

(52) U.S. Cl. 713/193

(57) ABSTRACT

Digital Rights Management (DRM) requirements are removed from aggregators (206) that store digital content. DRM is then utilized in the end-client (107) to render the digital content. Aggregators thus become “un-trusted” devices that store DRM-protected (usually encrypted) content. Client devices that wish to render the DRM-protected content will need to execute the appropriate DRM protocols with a rights issuer in order to do so.

### FIELD OF THE INVENTION

The present invention relates generally to digital-rights management and in particular, to a method and apparatus for providing protected digital content.

### BACKGROUND OF THE INVENTION

The ease at which valuable digital content (e.g., music, games, video, pictures, and books) can be copied and shared is worrisome to digital content owners. It is critical that digital content owners are fairly reimbursed. Because of this, it is a requirement that digital content distributors implement secure measures that help prevent piracy. Digital-Rights Management (DRM) is a phrase used to describe such protection of rights and the management of rules related to accessing and processing digital content. Digital content owners hope to protect their valuable digital content using a DRM system that is implemented by secure, tamper-resistant electronic devices.

FIG. 1 shows a prior-art solution for providing protected digital content to an end user, or client device. In FIG. 1, trusted aggregator 106 is provided that exists within premises 105. Premises 105 typically comprises a dwelling such as a house, however, premises 105 may comprise such things as automobiles, airplanes, movie theaters, buses, airports, . . . , etc.

Client device 107 comprises an application for rendering digital content. For example, client device 107 may comprise a cellular telephone capable of playing standard MPEG Audio Layer 3 (MP3) files. Other possible embodiments for digital content include, but are not limited to music, games, video, pictures, books, maps, software, etc. Digital content server 102 serves to provide such digital content to trusted aggregator 106 so that it can be accessed by client device 107. Aggregator 106 serves as storage means (such as a home hard drive), and stores digital content for access by client device 107. Additionally, metadata describing the stored digital content is also provided to trusted aggregator 106. Using aggregator 106 to preload digital content has two very important advantages; first it allows aggregator 106 to absorb external network 104 unreliability and delays, as well as absorbing the delays in downloading the digital content; second, it takes advantage of the high-speed local connectivity between aggregator 106 and client 107.

In order to protect the digital content provided to aggregator 106, DRM must be utilized. Rights issuer 101 serves to execute appropriate DRM protocols with trusted aggregator 106 so that content providers may confidently provide digital content to client device 107. For example, content server 102 may provide MP3 files to trusted aggregator 106 utilizing a DRM protocol as is being developed in MPEG-21 (ISO/IEC TR 21000-1:2001(E) “Part 1: Vision, Technologies and Strategy”, or by utilizing a DRM protocol as described in the OMA standard (Digital Rights Management Version 1.0, Version 05-September-2002, Open Mobile Alliance OMA-Download-DRM-v1_{—}0-20020905-a). Regardless of the DRM solution utilized, aggregator 106 becomes a trusted aggregator 106 and stores digital content to be accessed by client device 107.

Adding DRM to an aggregator makes aggregator 106 more expensive because it must be a trusted device. Additionally, aggregator 106 may need to serve clients that implement different DRM standards. Client 107 may wish to obtain content from other aggregators (such as at work, at home, at a friend's home, . . . , etc.); however, if both the aggregator and client are required to be trusted devices, then additional DRM requirements (such as domain keys) need to be implemented in all devices. Requiring all devices to be trusted and related (such as in domains) is not practical for situations where the client does not know apriori where it will obtain its content. Therefore, a need exists for a method and apparatus for providing protected digital content to a client device that does not require aggregator 106 to become a trusted aggregator.

### BRIEF DESCRIPTION OF THE DRAWINGS

FIG. 1 is a block diagram of a prior-art digital-rights management system.

FIG. 2 is a block diagram of a digital-rights management system.

FIG. 3 is a block diagram of the user equipment of FIG. 1 in accordance with the preferred embodiment of the present invention.

FIG. 4 is a flow chart showing operation of the user equipment of FIG. 3 in accordance with the preferred embodiment of the present invention.

### DETAILED DESCRIPTION OF THE DRAWINGS

To address the above-mentioned need, a method and apparatus for performing digital-rights management is disclosed herein. Particularly, DRM requirements are removed from aggregators. DRM is then utilized in the end-client. Aggregators become “un-trusted” devices that store DRM-protected (usually encrypted) content. Client devices that wish to render the DRM-protected content will need to execute the appropriate DRM protocols with a rights issuer in order to do so.

The creation of an un-trusted aggregator allows it to be more economically constructed and supported. Additionally, the benefits of an aggregator preloading bulk digital content and providing fast download over local networks are still realized.

Since aggregators do not implement DRM, they can not obtain the rights to decrypt the digital content. This is generally not a problem because aggregators do not actually use (rendering, etc.) the digital content. In the preferred embodiment of the present invention however, aggregators are allowed the use of the digital content metadata (title, description, icon, etc.) because this information is not DRM protected. Rendering the metadata may be useful in certain environments to allow the user to review/select digital content.

The present invention encompasses a method for operating a storage device. The method comprises the steps of obtaining metadata, obtaining encrypted digital content, storing the encrypted digital content, providing the metadata to a client device, and providing the encrypted digital content to the client device.

The present invention additionally encompasses an apparatus comprising a metadata transfer agent obtaining metadata about encrypted digital content, download circuitry obtaining encrypted digital content, and storage for storing the encrypted digital content. A first transfer agent is provided for transferring the metadata to a client device and a second transfer agent is provided for transferring the encrypted digital content to the client device.

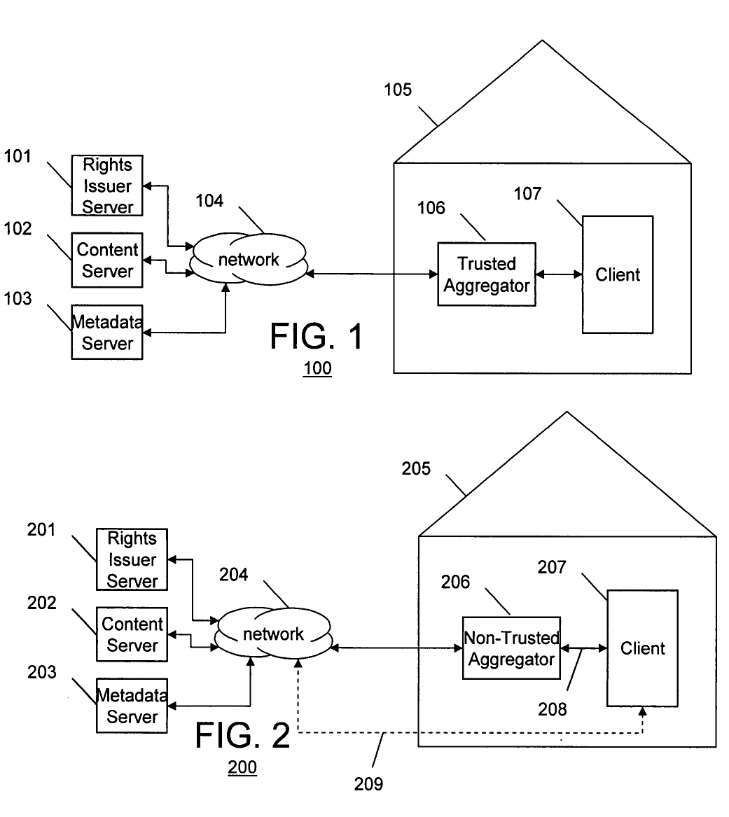

Turning now to the drawings wherein like numerals designate like components, FIG. 2 is a block diagram of DRM system 200. As with the prior-art system, In FIG. 1, content aggregator 206 is provided that exists within premises 105. Aggregator 206 serves as a local storage device for digital content. Premises 105 typically comprises a dwelling such as a house, however, premises 105 may comprise such things as automobiles, airplanes, theatres, train stations, work environment, . . . , etc.

Client device 207 comprises an application for rendering digital content. For example, client device 207 may comprise a cellular telephone capable of playing standard MPEG Audio Layer 3 (MP3) files. Other possible embodiments for digital content include, but are not limited to music, games, video, pictures, books, maps, software, etc. Digital content server 202 serves to provide such digital content to content aggregator 206 so that it can be accessed by client device 207. Aggregator 206 serves as storage means (such as a home hard drive), and stores digital content for access by client device 207. Additionally, metadata describing the stored digital content is also provided to content aggregator 206. As discussed above, using content aggregator 206 to preload digital content has two very important advantages; first it allows content aggregator 206 to absorb external network 204 unreliability and delays, as well as absorbing the delays in downloading the digital content; second, it takes advantage of the high-speed local connectivity between content aggregator 206 and client 207.

As discussed above, adding DRM to an aggregator makes the aggregator more expensive because it must be a trusted device. Additionally, the aggregator may need to serve clients that implement different DRM standards. In order to address this issue, in the preferred embodiment of the present invention content aggregator 206 is non-trusted in that it does not execute any DRM to become trusted. Although there are many DRM standards, most content delivery systems based on DRM involve two fundamental steps (1) transferring content that has been encrypted with a symmetric key, (2) transferring the symmetric key using a public key (typically bundled with “rights” on how the content may be used). Although there are many intermediate steps (authentication, device capabilities, billing, etc.), these steps are not part of the content transfer process, allowing DRM-protected content to be transferred and stored on content aggregator 206. It should also be noted that DRM schemes such as OMA 2.0 allow the content and rights transfer over different transports (HTTP, Bluetooth OBEX, IM, etc.) which requires only a trusted server and a trusted client but not trusted intermediate devices.

Because content aggregator 206 is un-trusted, content server 202 provides DRM-protected content for storage to content aggregator 206. Such DRM-protected content usually comprises encrypted content that cannot be rendered by content aggregator 206. Additionally, because content stored on content aggregator 206 is encrypted, client device 207 must use its trusted architecture components (typically called a DRM agent) to obtain rights and decryption keys in order to render the content stored on content aggregator 206.

Rights issuer 201 serves to execute appropriate DRM protocols with client 207 so that content providers may confidently provide digital content to client device 207. For example, content server 202 may provide encrypted MP3 files to non-trusted content aggregator 206. Client 207 becomes a trusted device by utilizing a DRM protocol. For example, The OMA 2.0 specification uses a protocol called ROAP for Rights Object Acquisition Protocol. This protocol allows a trusted client to request rights and keys from rights issuer 201. Although there are many details to the protocol (such as authentication, capabilities, etc.), the protocol fundamentally transfers the rights object (usage rights and content encryption key) from the rights issuer server 201 to the client 207 using the client's public key. Using the ROAP protocol the client sends its public key to the rights issuer 201. The rights issuer 201 then encrypts the content encryption key and usage rights with the client's public key and returns the result rights object to the client. The client 207 then uses its private key to decrypt the content encryption key and rights to allow the client 207 to use the content.

In the preferred embodiment of the present invention client device 207 communicates with rights issuer 201 through a direct connection to network 204. Network 204 may comprise any Wide Area Network, or Local Area Network. Such networks include, but are not limited to over-the-air networks such as cellular networks, 802.11, . . . , etc. In alternate embodiments of the present invention, client device may communicate to rights issuer 201 by communication through non-trusted content aggregator 206 acting as a proxy, using content aggregator 206 to request rights to use to content. In the preferred embodiment of the present invention client 207 is a typical handset supporting DRM standards (such as OMA). To provide mobility, client device 207 provides local bulk storage. The encrypted content is transferred from content aggregator 206 along with optional metadata. Although the metadata is not required for client device 207 to use the content, it would typically be useful for client applications for organizing, indexing, reviewing, etc.

At this point, client device 207 has two options to obtain the rights object to enable the DRM agent. While still connected to the content aggregator 206, client device 207 may request the rights object over local connection 208 using the content aggregator 206 to download the rights. This situation is typical of “down load the content, download the rights and go” type of scenario. If client device 207 does not want to obtain the rights for the content right away (e.g. not all of the content is relevant or will not be used or the person is in a hurry), then client device 207 may disconnect from content aggregator 206 and go portable. If client device 207 wants to use the content when mobile, client device 207 may load the rights object through any available wireless network (such as WAN or an 802.11 hotspot). Loading the rights object while mobile is not an issue because the rights object is typically small (on the order of a few KB) whereas the content is generally significant (on the order of MB or GB). Once client device 207 has obtained both the content and rights object, applications may use the content through the DRM agent according to the rights.

Aggregator 206 utilizes syndication technology (e.g. RSS, Atom) to determine potential content for downloading. Content to download is selected based on some criteria or may be based on user interaction. The encrypted content is downloaded and stored in content aggregator 206; however as discussed, content aggregator 206 cannot decode/use the content because it does not support DRM. The stored content is transferred (generally over a high-speed local network) to end-clients that do support DRM. While the end-client is connected to content aggregator 206, the end-client can take advantage of the high-speed local connection to review what content is available using the syndication metadata and may additionally use content aggregator 206 as a proxy to request the rights object to use content. In some instances, obtaining the rights object may result in financial transactions to allow the content owner payment for the use of the content.

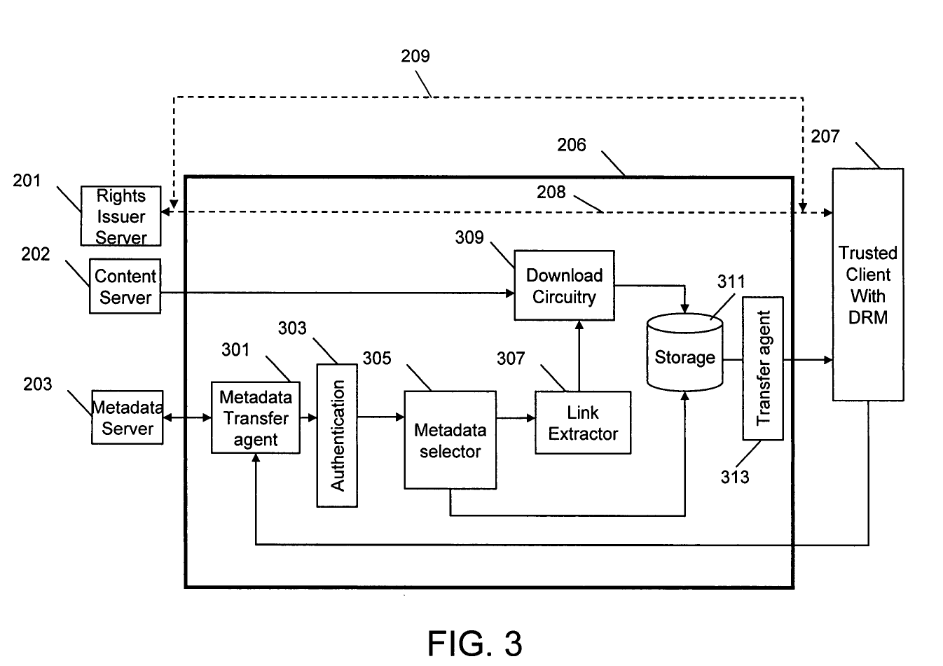

FIG. 3 is a more-detailed block diagram of the aggregator of FIG. 2. As shown, content aggregator 206 comprises metadata transfer agent 301, authentication circuitry 303, metadata selector 305, link extractor 307, download circuitry 309, and storage 311. During operation, transfer agent 301 selects metadata from server 203. Typically, transfer agent 301 contains a list of URLs pointing to metadata servers. It should also be noted to one skilled in the art that fetching metadata may also be done as a push operation—syndication servers 203 may push new metadata to transfer agent 301 over (for example) XMPP. In another embodiment, metadata may be obtained from local devices pushing metadata using (for example) Bluetooth Object Push Profile. Finally, metadata may be obtained at the request of client 207.

Once metadata is obtained, authentication circuitry 303 authenticates the metadata. This step is optional but may be implemented to ensure the metadata comes from a trusted source. This is particularly important where the metadata is pushed to the content aggregator 206 as an event (because there is no way to prove who the sender is—e.g. if it arrives as an e-mail attachment). Verifying a signature typically requires obtaining the public key for the purported sender. Once the public key is obtained, a message digest and hash of the metadata is computed. The enclosed hash of the signature is then decoded with the public key. If the resulting hash matches the locally computed hash, then it can be verified that the sender with the purported public key has signed the metadata. One additional step may be used to verify the purported public key is authentic by requesting the signer's certificate (which is signed by a trusted authority) to verify the public key actually belongs to the sender. An alternate method to verify the signature is to use PGP's (pretty good privacy) “web of trust” model where there is no centralized certification authority and people need to develop public key trust through other means (such as sending it via e-mail). Regardless of what method is used to verify the signature (or if it is implemented at all), the metadata is stored and sent to the next block.

Once authenticated, metadata selector will be used to extract metadata of interest. In the simplest form, all metadata is passed from authentication circuitry 303 by selector 305. Other embodiments may allow metadata that is only a specific age (e.g. no content older than . . . ) or according to a filtering requirement (metadata containing only “football”). One embodiment may use a display device to render the metadata allowing a user to perform manual selection. The rendering may be on a local television monitor with manual selection occurring with a menu system. Although there are many instantiations of this component, the output is a set of metadata of desired content. The selected metadata is stored in storage 311.

Links to the digital content are extracted from the metadata by link extractor 307. This is typically done by using an XML parser on the metadata. The output of this block is a list of links of where to obtain the (encrypted) content from.

Once the links are obtained, download circuitry 309 stores the encrypted content in storage 311 by accessing content server 202 and downloading the encrypted content. Encrypted content includes, but not limited to, encrypted digital images (such as JPEGs), encrypted digital audio (such as MP3s), encrypted digital video (such as MPEG4), encrypted slide shows (such as SMIL), encrypted text documents, etc. At this point, the content aggregator 206 has both metadata describing content and encrypted content in its local store. Optionally, the metadata may be reviewed to see what content is available or to select specific content. It should be noted the metadata is not DRM protected (i.e., unencrypted). The metadata typically consists of a title, unique ID, publication date, thumbnail icon, etc. to allow the user to determine the nature of the content.

Client devices connect to storage 311, typically through transfer agent 313. Different protocols may be used to transfer digital content, depending on the type of end-clients it needs to support. Transfer agent 313 may be a synchronization type of server (e.g. SyncML) over various transports (such as 802.11, USB or Bluetooth). Transfer agent 313 may also use streaming protocols (such as RTP over HTTP).

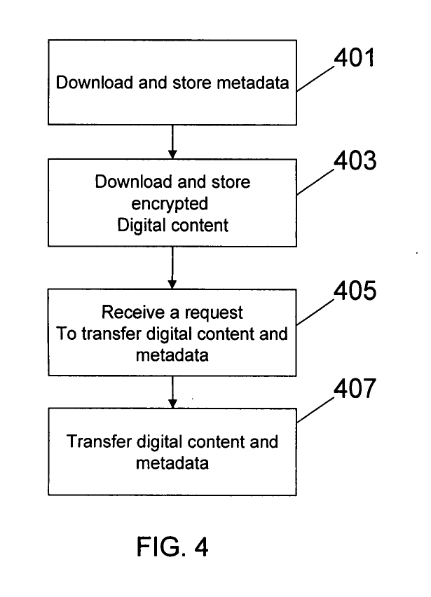

FIG. 4 is a flow chart showing operation of content aggregator 206. The logic flow begins at step 401 where metadata is obtained and stored in storage 311. At step 403 download circuitry 309 obtains and stores pre-encrypted digital content (i.e., digital content that has already been encrypted). Preferably, the content is obtained from links provided by the metadata. As discussed above, the metadata is not DRM protected, while the digital content is DRM protected. Additionally, both the metadata and the encrypted digital content are preferably (though not necessarily) obtained over a wide-area network. At step 405 a request is received to transfer a digital content and/or metadata to client 207. Examples of the request may be automatic from a client 207 establishing a docking connection with 206 or the request may be manually triggered from a user reviewing the metadata on client 207 or the request may be manually triggered by an application on client 207 (such as a state-based synchronization algorithm). Finally, at step 407 the content and/or metadata is provided to client 207, preferably (although not necessarily) over a local-area network. As discussed above, client device 207 will have to obtain the rights object to enable the rendering of the digital content. Client device 207 may request the rights object over local connection 208. If client device 208 does not want to obtain the rights for the content right away (e.g. not all of the content is relevant or will not be used or the person is in a hurry), then client device 207 may disconnect from content aggregator 206 and go portable. If client device 207 wants to use the content when mobile, client device 207 may load the rights object through any available wireless network through path 209 (such as WAN or an 802.11 hotspot).

While the invention has been particularly shown and described with reference to a particular embodiment, it will be understood by those skilled in the art that various changes in form and details may be made therein without departing from the spirit and scope of the invention. For example, while storage 311 is provided to store both metadata and encrypted digital content, one of ordinary skill in the art will recognize that separate storage may be employed to store each. It is intended that such changes come within the scope of the following claims.

1. A method for operating a storage device, the method comprising the steps of:
obtaining metadata;
obtaining encrypted digital content;
storing the encrypted digital content; and
providing the encrypted digital content to the client device.

2. The method of claim 1 wherein the step of obtaining the metadata comprises the step of obtaining unencrypted metadata.

3. The method of claim 1 further comprising the step of:
storing the metadata.

4. The method of claim 1 wherein the step of obtaining encrypted digital content comprises the step of obtaining the encrypted digital content from links provided by the metadata.

5. The method of claim 1 wherein the step of obtaining encrypted digital content comprises the step of obtaining digital content that is pre-encrypted.

6. The method of claim 1 further comprising the step of:
authenticating the metadata.

7. The method of claim 1 wherein the step of providing the encrypted digital content to the client device comprises the step of providing the encrypted digital content to the client device when requested by the client device.

8. The method of claim 1 wherein the step of obtaining the encrypted digital content comprises the step of obtaining the encrypted digital content over a wide-area network.

9. The method of claim 8 wherein the step of providing the encrypted digital content to the client device over a local-area network.

10. The method of claim 1 wherein the step of providing the encrypted digital content to the client device over a local-area network.

11. The method of claim 1 further comprising the steps of:
providing the metadata to a client device.

12. An apparatus comprising:
a metadata transfer agent obtaining metadata about encrypted digital content;
download circuitry obtaining encrypted digital content;
storage for storing the encrypted digital content; and
a first transfer agent for providing the encrypted digital content to the client device.

13. The apparatus of claim 12 wherein the metadata comprises unencrypted metadata.

14. The apparatus of claim 12 wherein the storage additionally stores the metadata.

15. The apparatus of claim 12 wherein the encrypted digital content is obtained from links provided by the metadata.

16. The apparatus of claim 12 wherein the digital content that is pre-encrypted.

17. The apparatus of claim 12 further comprising authentication circuitry for authenticating the metadata.

18. The apparatus of claim 12 the encrypted digital content is provided to the client device when requested by the client device.

19. The apparatus of claim 12 wherein the encrypted digital content is obtained over a wide-area network.

20. The apparatus of claim 12 further comprising:
a second transfer agent for providing the metadata to a client device.
